(19) United States
(12) Patent Application Publication
(10) Pub. No.: US 2019/0359368 A1
(43) Pub. Date: Nov. 28, 2019

(54) BOX SEALING ASSEMBLY

(71) Applicant: Anne-Sophie Trzebinski-Lemarti, Basalt, CO (US)

(72) Inventor: Anne-Sophie Trzebinski-Lemarti, Basalt, CO (US)

(21) Appl. No.: 15/985,790

(22) Filed: May 22, 2018

(51) Int. Cl. B65D 5/02; C09J 7/29

(52) U.S. Cl. CPC B65D 5/0236; C09J 7/29

(57) ABSTRACT

A box sealing assembly includes a cardboard box that has a set of top flaps, a set of bottom flaps and an outer wall. A set of top adhesive strips is each coupled to a respective one of the top flaps. Each of the top adhesive strips adhesively engages the cardboard box when each of the top flaps is closed thereby retaining each of the top flaps in the closed position. A set of bottom adhesive strips is each coupled to a respective one of the bottom flaps. Each of the bottom adhesive strips adhesively engages the cardboard box when each of the bottom flaps is closed thereby retaining each of the bottom flaps is closed.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to sealing devices and more particularly pertains to a new sealing device for sealing and unsealing a cardboard box.

### BRIEF SUMMARY OF THE INVENTION

An embodiment of the disclosure meets the needs presented above by generally comprising a cardboard box that has a set of top flaps, a set of bottom flaps and an outer wall. A set of top adhesive strips is each coupled to a respective one of the top flaps. Each of the top adhesive strips adhesively engages the cardboard box when each of the top flaps is closed thereby retaining each of the top flaps in the closed position. A set of bottom adhesive strips is each coupled to a respective one of the bottom flaps. Each of the bottom adhesive strips adhesively engages the cardboard box when each of the bottom flaps is closed thereby retaining each of the bottom flaps is closed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a box sealing assembly according to an embodiment of the disclosure.

FIG. 2 is a top phantom view of an embodiment of the disclosure.

FIG. 3 is a bottom perspective view of an embodiment of the disclosure showing top flaps being closed.

FIG. 4 is a perspective in-use view of an embodiment of the disclosure showing a top pull string being torn through a top adhesive strip.

FIG. 5 is a perspective view of a top adhesive layer of an embodiment of the disclosure.

FIG. 6 is a front view of an embodiment of the disclosure.

FIG. 7 is a right side view of an embodiment of the disclosure.

### DETAILED DESCRIPTION OF THE INVENTION

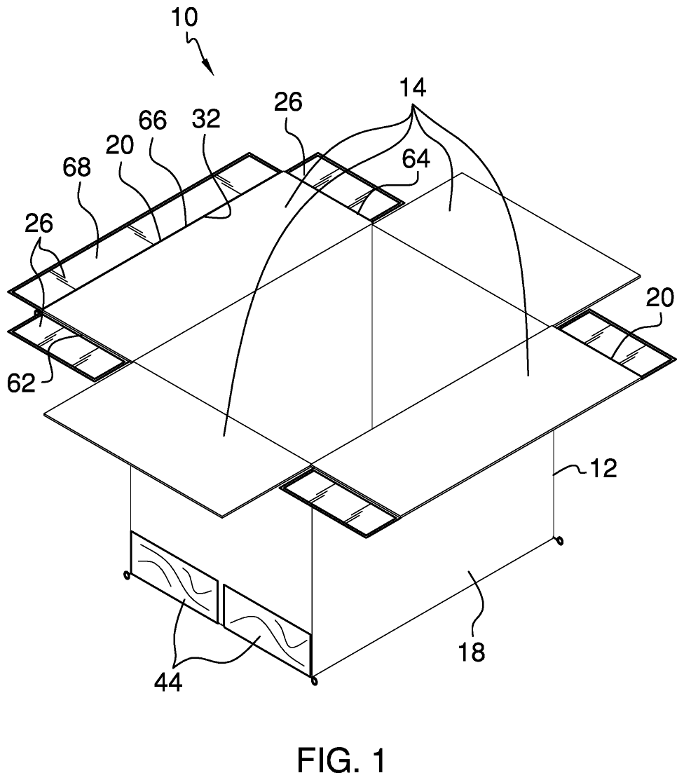

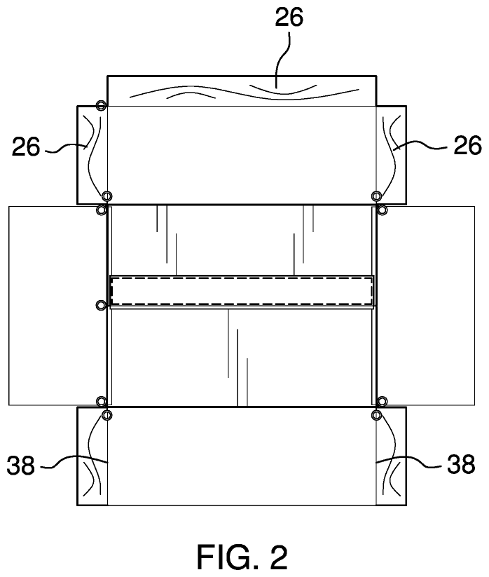

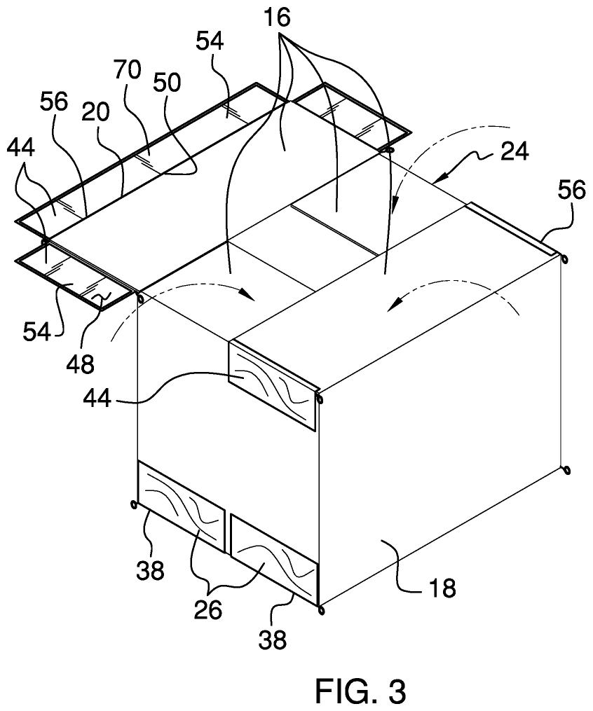

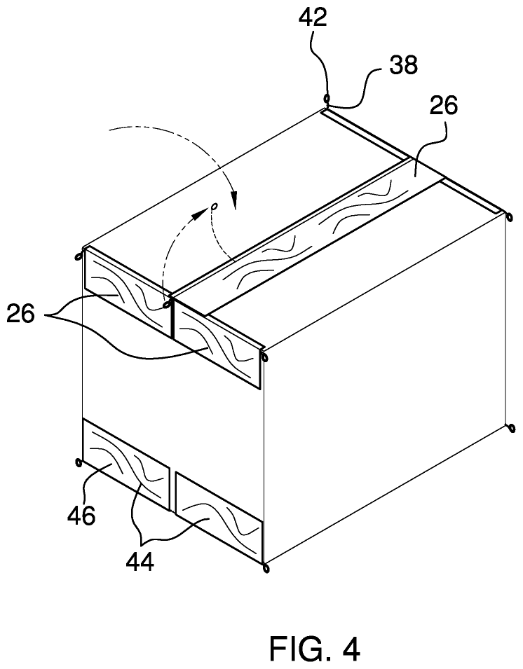

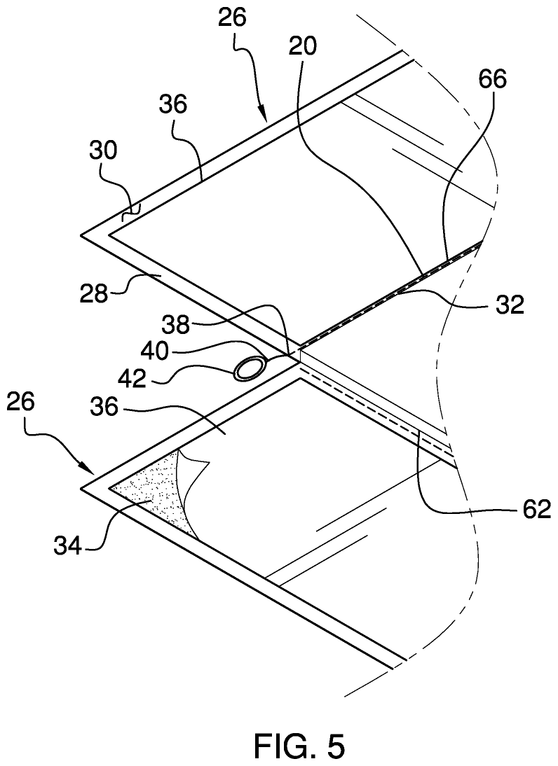

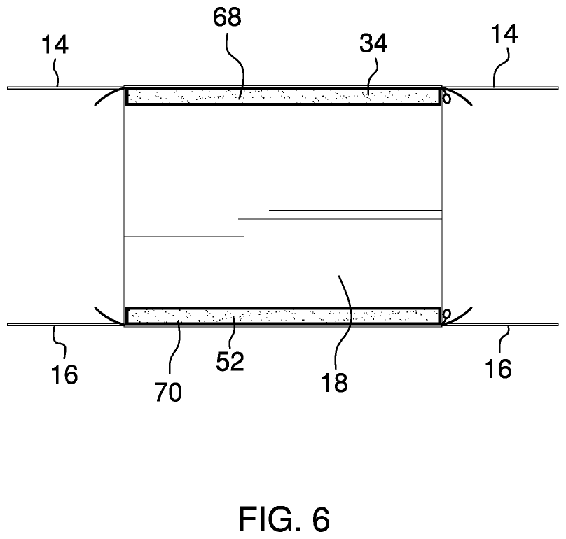

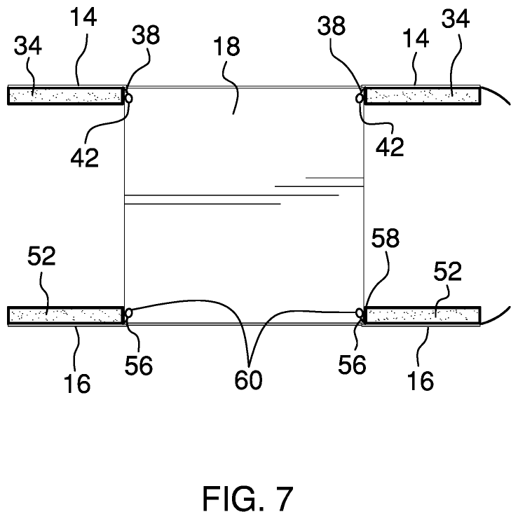

With reference now to the drawings, and in particular to FIGS. 1 through 7 thereof, a new sealing device embodying the principles and concepts of an embodiment of the disclosure and generally designated by the reference numeral 10 will be described.

As best illustrated in FIGS. 1 through 7, the box sealing assembly 10 generally comprises a cardboard box 12 has a set of top flaps 14, a set of bottom flaps 16 and an outer wall 18. Each of the top flaps 14 and the bottom flaps 16 has outer edge 20. Each of the top flaps 14 is foldable inwardly to close a top end 22 of the cardboard box 12 and each of the bottom flaps 16 is foldable inwardly to close a bottom end 24 of the cardboard box 12. The cardboard box 12 may be a cardboard box of any conventional size and design, including but not being limited to, postal shipping boxes and moving boxes.

A set of top adhesive strips 26 is provided and each of the top adhesive strips 26 is coupled to a respective one of the top flaps 14. Each of the top adhesive strips 26 adhesively engages the cardboard box 12 when each of the top flaps 14 is closed. In this way each of the top flaps 14 is retained in the closed position. Each of the top adhesive strips 26 comprises a top panel 28 that has a first surface 30 and an outside edge 32. The outside edge 32 is coupled to the outer edge 20 of a respective one of the top flaps 14.

A top adhesive layer 34 is positioned on and completely covers the first surface 30 of the top panel 28. The top adhesive layer 34 adhesively engages the cardboard box 12 when the respective top flap 14 is closed to retain the respective top flap 14 in the closed position. A top protective sheet 36 is removably coupled to and completely covers the top adhesive layer 34 such that the top protective sheet 36 inhibits the top adhesive layer 34 from adhering. The top protective sheet 36 is removable from the top adhesive layer 34 for adhering to the cardboard box 12.

A plurality of top pull strings 38 is provided and each of the top pull strings 38 is coupled to a respective one of the top adhesive strips 26. Each of the top pull strings 38 tears through the respective top adhesive strip when the top pull strings 38 are pulled for opening the top flaps 14. Each of the top pull strings 38 is positioned between the top adhesive layer 34 and the top panel 28 of the respective top adhesive strips 26. Moreover, each of the top pull strings 38 has an exposed end 40 with respect to the respective top adhesive strip. A plurality of top rings 42 is each coupled to the exposed end 40 of a respective one of the top pull strings 38 for gripping thereby facilitating the respective top pull string 38 to be torn through the respective top adhesive strip.

A set of bottom adhesive strips 44 is provided and each of the bottom adhesive strips 44 is coupled to a respective one of the bottom flaps 16. Each of the bottom adhesive strips 44 adhesively engages the cardboard box 12 when each of the bottom flaps 16 is closed thereby retaining each of the bottom flaps 16 in the closed position. Each of the bottom adhesive strips 44 comprises a bottom panel 46 that has a first surface 48 and an outside edge 50. The outside edge 50 of the bottom panel 46 is coupled to and is coextensive with the outer edge 20 of a respective one of the bottom flaps 16.

A bottom adhesive layer 52 is positioned on and completely covers the first surface 48 of the bottom panel 46. The bottom adhesive layer 52 adhesively engages the cardboard box 12 when the respective bottom flap 16 is closed to retain the respective bottom flap 16 in the closed position. A bottom protective sheet 54 is removably coupled to and completely covers the bottom adhesive layer 52 such that the bottom protective sheet 54 inhibits the bottom adhesive layer 52 from adhering. The bottom protective sheet 54 is removable from the bottom adhesive layer 52 for adhering. Each of the top 34 and bottom 52 adhesive layers may be a high bonding strength, single use adhesive or the like.

A plurality of bottom pull strings 56 is provided and each of the bottom pull strings 56 is coupled to a respective one of the bottom adhesive strips 44. Each of the bottom pull strings 56 tears through the respective bottom adhesive strip 44 when the bottom pull strings 56 are pulled for opening the bottom flaps 16. Each of the bottom pull strings 56 is positioned between the bottom adhesive layer 52 and the bottom panel 46 of the respective bottom adhesive strips 44. Additionally, each of the bottom pull strings 56 has an exposed end 58 with respect to the respective bottom adhesive strip 44. A plurality of bottom rings 60 is each coupled to the exposed end 40 of a respective one of the bottom pull strings 56 for gripping thereby facilitating the respective bottom pull string 56 to be torn through the respective bottom adhesive strip 44.

The outer edge 20 of each of the top 14 and bottom flaps 16 has a first lateral side 62, a second lateral side 64 and a longitudinal side 66 extending therebetween. The plurality of top adhesive strips 26 is each positioned on a respective one of the first 62 and second 64 lateral sides of the respective top flap 14. Additionally, the plurality of top adhesive strips 26 includes a longitudinal strip 68 that is positioned on the longitudinal side 66 of a respective one of the top flaps 14. The plurality of bottom adhesive strips 44 is positioned on a respective one of the first 62 and second 64 lateral sides of the respective bottom flap 16. The plurality of bottom adhesive strips includes 44 a longitudinal strip 70 and the longitudinal strip 70 associated with the bottom adhesive strips 44 is positioned on the longitudinal side 66 of a respective one of the bottom flaps 16.

In use, the cardboard box 12 is unfolded from a flattened position and each of the bottom flaps 16 is closed. The bottom protective sheet 54 on each of the bottom adhesive strips 44 is removed and each of the bottom adhesive strips 44 is folded downwardly along the outer wall 18 of the cardboard box 12. The bottom protective sheet 54 on the longitudinal strip 70 associated with the bottom adhesive strips 44 is removed and the bottom adhesive layer 52 on the longitudinal strip 70 associated with the bottom adhesive strips 44 adheres the adjacent bottom flap 16. In this way the bottom flaps 16 are retained in the closed position.

The cardboard box 12 is filled with selected objects and the top flaps 14 are closed. The top protective sheet 36 on each of the top adhesive strips 26 is removed and each of the top adhesive strips 26 is folded downwardly along the outer wall 18 of the cardboard box 12. The top protective sheet 36 on the longitudinal strip 68 associated with the top adhesive strips 26 is removed and the top adhesive layer 34 on the longitudinal strip 68 associated with the top adhesive strips 26 adheres the adjacent top flap 14. In this way the top flaps 14 are retained in the closed position. The top rings 42 are gripped and each of the top pull strings 38 is torn through the respective top adhesive strip 26 to open the top flaps 14. Additionally, the bottom rings 60 are gripped and each of the bottom pull strings 56 is torn through the respective bottom adhesive strip 44 to open the bottom flaps 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A box sealing assembly for sealing a box closed and subsequently unsealing the box, the assembly comprising:
a cardboard box having a set of top flaps, a set of bottom flaps and an outer wall, each of the top flaps and the bottom flaps has an outer edge, each of the top flaps being foldable inwardly to close a top end of the cardboard box, each of the bottom flaps being foldable inwardly to close a bottom end of the cardboard box;
a set of top adhesive strips, each of the top adhesive strips being coupled to a respective one of the top flaps, each of the top adhesive strips adhesively engaging the cardboard box when each of the top flaps is closed thereby retaining each of the top flaps being closed, each of the top adhesive strips comprises a top panel having a first surface and an outside edge, the outside edge being coupled to the outer edge of a respective one of the top flaps;
a top adhesive layer being positioned on and covering an exposed portion of the first surface of the top panel extending away from the outside edge, the top adhesive layer adhesively engaging the cardboard box when the respective top flap is closed to retain the respective top flap being closed;
a top protective sheet being removably coupled to and completely covering the top adhesive layer covering the exposed portion of the first surface such that the top protective sheet inhibits the top adhesive layer on the exposed portion of the first surface from adhering, the top protective sheet being removable from the top adhesive layer for adhering;
a plurality of top pull strings, each of the top pull strings being coupled to a respective one of the top adhesive strips along the outside edge, each of the top pull strings tearing through the respective top adhesive strip when the top pull strings are pulled for opening the top flaps;
a set of bottom adhesive strips, each of the bottom adhesive strips being coupled to a respective one of the bottom flaps, each of the bottom adhesive strips adhesively engaging the cardboard box when each of the bottom flaps is closed thereby retaining each of the bottom flaps being closed; and
a plurality of bottom pull strings, each of the bottom pull strings being coupled to a respective one of the bottom adhesive strips, each of the bottom pull strings tearing through the respective bottom adhesive strip when the bottom pull strings are pulled for opening the bottom flaps.

2. (canceled)

3. The assembly according to claim 1, wherein each of the top pull strings is positioned between the top adhesive layer and the top panel of the respective top adhesive strips, each of the top pull strings having an exposed end with respect to the respective top adhesive strip.

4. The assembly according to claim 3, further comprising a plurality of top rings, each of the top rings being coupled to the exposed end of a respective one of the top pull strings for gripping thereby facilitating the respective top pull string to be torn through the respective top adhesive strip.

5. The assembly according to claim 1, wherein:
each of the top flaps and the bottom flaps has an outer edge, each of the top flaps being foldable inwardly to close a top end of the cardboard box, each of the bottom flaps being foldable inwardly to close a bottom end of the cardboard box;
each of the bottom adhesive strips comprises a bottom panel having a first surface and an outside edge, the outside edge of the bottom panel being coupled to the outer edge of a respective one of the bottom flaps;
a bottom adhesive layer being positioned on and completely covering the first surface of the bottom panel, the bottom adhesive layer adhesively engaging the cardboard box when the respective bottom flap is closed to retain the respective bottom flap being closed; and
a bottom protective sheet being removably coupled to and completely covering the bottom adhesive layer such that the bottom protective sheet inhibits the bottom adhesive layer from adhering, the bottom protective sheet being removable from the bottom adhesive layer for adhering.

6. The assembly according to claim 5, wherein each of the bottom pull strings is positioned between the bottom adhesive layer and the bottom panel of the respective bottom adhesive strips, each of the bottom pull strings having an exposed end with respect to the respective bottom adhesive strip.

7. The assembly according to claim 6, further comprising a plurality of bottom rings, each of the bottom rings being coupled to the exposed end of a respective one of the bottom pull strings for gripping thereby facilitating the respective bottom pull string to be torn through the respective bottom adhesive strip.

8. A box sealing assembly for sealing a box closed and subsequently unsealing the box, the assembly comprising:
a cardboard box having a set of top flaps, a set of bottom flaps and an outer wall, each of the top flaps and the bottom flaps having outer edge, each of the top flaps being foldable inwardly to close a top end of the cardboard box, each of the bottom flaps being foldable inwardly to close a bottom end of the cardboard box;
a set of top adhesive strips, each of the top adhesive strips being coupled to a respective one of the top flaps, each of the top adhesive strips adhesively engaging the cardboard box when each of the top flaps is closed thereby retaining each of the top flaps being closed, each of the top adhesive strips comprising:
a top panel having a first surface and an outside edge, the outside edge being coupled to the outer edge of a respective one of the top flaps;
a top adhesive layer being positioned on and covering an exposed portion of the first surface of the top panel extending away from the outside edge, the top adhesive layer adhesively engaging the cardboard box when the respective top flap is closed to retain the respective top flap being closed; and
a top protective sheet being removably coupled to and completely covering the top adhesive layer covering the exposed portion of the first surface such that the top protective sheet inhibits the top adhesive layer on the exposed portion of the first surface from adhering, the top protective sheet being removable from the top adhesive layer for adhering;
a plurality of top pull strings, each of the top pull strings being coupled to a respective one of the top adhesive strips, each of the top pull strings tearing through the respective top adhesive strip when the top pull strings are pulled for opening the top flaps, each of the top pull strings being positioned between the top adhesive layer and the top panel of the respective top adhesive strips, each of the top pull strings having an exposed end with respect to the respective top adhesive strip;
a plurality of top rings, each of the top rings being coupled to the exposed end of a respective one of the top pull strings for gripping thereby facilitating the respective top pull string to be torn through the respective top adhesive strip;
a set of bottom adhesive strips, each of the bottom adhesive strips being coupled to a respective one of the bottom flaps, each of the bottom adhesive strips adhesively engaging the cardboard box when each of the bottom flaps is closed thereby retaining each of the bottom flaps being closed, each of the bottom adhesive strips comprising:
a bottom panel having a first surface and an outside edge, the outside edge of the bottom panel being coupled to the outer edge of a respective one of the bottom flaps;
a bottom adhesive layer being positioned on and completely covering the first surface of the bottom panel, the bottom adhesive layer adhesively engaging the cardboard box when the respective bottom flap is closed to retain the respective bottom flap being closed; and
a bottom protective sheet being removably coupled to and completely covering the bottom adhesive layer such that the bottom protective sheet inhibits the bottom adhesive layer from adhering, the bottom protective sheet being removable from the bottom adhesive layer for adhering;
a plurality of bottom pull strings, each of the bottom pull strings being coupled to a respective one of the bottom adhesive strips, each of the bottom pull strings tearing through the respective bottom adhesive strip when the bottom pull strings are pulled for opening the bottom flaps, each of the bottom pull strings being positioned between the bottom adhesive layer and the bottom panel of the respective bottom adhesive strips, each of the bottom pull strings having an exposed end with respect to the respective bottom adhesive strip; and
a plurality of bottom rings, each of the bottom rings being coupled to the exposed end of a respective one of the bottom pull strings for gripping thereby facilitating the respective bottom pull string to be torn through the respective bottom adhesive strip.
